(19) United States
(12) Patent Application Publication
(10) Pub. No.: US 2009/0040661 A1
(43) Pub. Date: Feb. 12, 2009

(54) TUNNELING MAGNETIC SENSING ELEMENT AND METHOD FOR MAKING THE SAME

(75) Inventors: Kenichi Tanaka, Niigata-ken (JP); Eiji Umetsu, Niigata-ken (JP); Kazuaki Ikarashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 12/256,149

(22) Filed: Oct. 22, 2008

(30) Foreign Application Priority Data
Oct. 24, 2006 (JP) 2006-288896
Oct. 24, 2007 (JP) PCT/JP2007/070700

(51) Int. Cl. G11B 5/127

(52) U.S. Cl. 360/324.1

(57) ABSTRACT

An insulating barrier layer including a lower insulating layer composed of Al—O and an upper insulating layer composed of CoFe—O and disposed on the lower insulating layer is formed on a second pinned magnetic layer. A free magnetic layer is formed on the insulating barrier layer. According to this structure, a high rate of change in resistance (ΔR/R) and a low RA (element resistance R×element area A) can be achieved.

### CLAIM OF PRIORITY

This application claims benefit of the Japanese Patent Application No. 2006-288896 filed on Oct. 24, 2006, which is hereby incorporated by reference.

### BACKGROUND OF THE INVENTION

1. Field of the Invention

The present invention relates to a tunneling magnetic sensing element to be mounted in a hard disk device or for use as a magnetoresistive memory (MRAM), for example.

In particular, it relates to a tunneling magnetic sensing element that can achieve a low resistance-area product (RA) and a high rate of change in resistance (ΔR/R), and to a method for making the tunneling magnetic sensing element.

2. Description of the Related Art

A tunneling magnetic sensing element is a device having resistance changed by a tunneling effect. When the magnetization direction of a pinned magnetic layer is antiparallel to the magnetization direction of a free magnetic layer, a tunneling current does not smoothly flow through an insulating barrier layer (tunneling barrier layer) disposed between the pinned magnetic layer and the free magnetic layer, thereby maximizing the resistance. In contrast, when the magnetization direction of the pinned magnetic layer is parallel to the magnetization direction of the free magnetic layer, the tunneling current smoothly flows and the resistance is minimized thereby.

As the magnetization direction of the free magnetic layer changes by the effect of an external magnetic field on the basis of this principle, the changes in electrical resistance are detected as changes in voltage so as to detect a leakage magnetic field from a recording medium.

The properties such as the rate of change in resistance (ΔR/R) change with the material of the insulating barrier layer. Thus, it has been necessary to conduct investigations for every material of the insulating barrier layer.

The properties important for the tunneling magnetic sensing elements are the rate of change in resistance (ΔR/R), RA (element resistance R×element area A), and the like. Improvements of the material and the layer structure of the insulating barrier layer are being made to optimize these properties.

Japanese Unexamined Patent Application Publication No. 2004-200245 describes a pinned magnetic layer having a first composite magnetic layer, which prevents diffusion of the material constituting an antiferromagnetic layer into a tunneling insulating layer. Paragraph [0011] of this patent document describes that an oxide layer composed of a ferromagnetic element, such as FeOₓ or CoFeₓ, is interposed between the pinned magnetic layer and the tunneling insulating layer. However, paragraph [0011] also points out that such a structure suffers from a decrease in MR ratio and an increase in junction resistance.

Accordingly, in this patent document, a structure that can simultaneously achieve a decrease in RA and an increase in rate of change in resistance (ΔR/R) is not described.

The invention described in Japanese Unexamined Patent Application Publication No. 2002-232040 ('040 document) provides a two-layer insulating barrier layer constituted by a first barrier sublayer and a second barrier sublayer both composed of, for example, an aluminum oxide. However, the two-layer insulating barrier layer constituted by the first barrier sublayer and the second barrier sublayer has an increased thickness, and, as shown in FIGS. 8 and 24 of the '040 document, RA increases as a result. Thus, it has been difficult to simultaneously achieve a decrease in RA and an increase in rate of change in resistance (ΔR/R).

### SUMMARY OF THE INVENTION

The present invention provides a tunneling magnetic sensing element that can achieve a high rate of change in resistance (ΔR/R) and a low RA and a method for making the tunneling magnetic sensing element.

An aspect of the present invention provides a tunneling magnetic sensing element that includes a pinned magnetic layer having a magnetization direction pinned; an insulating barrier layer; and a free magnetic layer having a magnetization direction variable with an external magnetic field. In this tunneling magnetic sensing element, the pinned magnetic layer, the insulating barrier layer, and the free magnetic layer are stacked in that order or a reversed order from the bottom. The insulating barrier layer has a layered structure that includes a pinned magnetic layer-side insulating layer composed of Al—O or Mg—O disposed at the interface between the pinned magnetic layer and the insulating barrier layer and a free magnetic layer-side insulating layer composed of CoFe—O disposed at the interface between the free magnetic layer and the insulating barrier layer.

Preferably, the average thickness of the free magnetic layer-side insulating layer is smaller than the average thickness of the pinned magnetic layer-side insulating layer.

Interdiffusion of constituent elements may occur at the interface between the free magnetic layer-side insulating layer and the pinned magnetic layer-side insulating layer.

Since the CoFe—O insulating layer is formed at the free magnetic layer-side of the insulating barrier layer and the Al—O insulating layer is formed at the pinned magnetic layer-side, a high rate of change in resistance (ΔR/R) and low RA (element resistance R×element area A) can be achieved effectively. In particular, compared to a related structure (structure having an insulating barrier layer formed as an Al—O single layer), a lower RA and a rate of change in resistance (ΔR/R) comparable or superior to that of the related structure can be achieved. Alternatively, Al—O may be replaced with Mg—O.

Preferably, the pinned magnetic layer, the insulating barrier layer, and the free magnetic layer are stacked in that order from the bottom. The pinned magnetic layer may have a layered structure at least including an insulating barrier layer-side magnetic layer in contact with the insulating barrier layer, and the insulating barrier layer-side magnetic layer may be composed of CoFeB or has a layered structure including a CoFeB layer in contact with the insulating barrier layer and a CoFe layer.

Another aspect of the present invention provides a method for making a tunneling magnetic sensing element, comprising stacking a pinned magnetic layer having a magnetization direction pinned, an insulating barrier layer, and a free magnetic layer having a magnetization direction variable with an external magnetic field, either in that order or a reversed order from the bottom. In this method, in forming the insulating barrier layer, an Al layer or a Mg layer is formed at the side in contact with the pinned magnetic layer, a CoFe layer is formed at the side in contact with the free magnetic layer, and then the Al or Mg layer and the CoFe layer are oxidized.

According to this method, a tunneling magnetic sensing element that can achieve a high rate of change in resistance (ΔR/R) and a low RA (element resistance R×element area A) can be easily and adequately produced.

In this method, the average thickness of the CoFe layer is preferably more than 0 Å but not more than 1.6 Å. In this manner, compared to a related structure (structure having an insulating barrier layer formed as an Al—O single layer), a lower RA and a rate of change in resistance (ΔR/R) comparable or superior to that of the related structure can be achieved effectively. The average thickness of the CoFe layer is more preferably more than 0 Å but not more than 1.2 Å since a high rate of change in resistance (ΔR/R) can be obtained more adequately.

The pinned magnetic layer, the insulating barrier layer, and the free magnetic layer are preferably stacked in that order from the bottom, and in forming the insulating barrier layer, the Al or Mg layer and the CoFe layer are preferably stacked in that order from the bottom and then oxidized.

### BRIEF DESCRIPTION OF THE DRAWINGS

FIG. 1 is a cross-sectional view of a tunneling magnetic sensing element of an embodiment taken in a direction parallel to a surface facing a recording medium;

FIG. 2 is an enlarged view of an insulating barrier layer 5 shown in FIG. 5 and contains a partial enlarged cross-sectional view showing interdiffusion of elements between an Al—O lower insulating layer and a CoFe—O upper insulating layer and a graph showing Al concentration gradient;

FIG. 3 contains a partial enlarged cross-sectional view of another embodiment of an insulating barrier layer 5 shown in FIG. 1 and a graph showing Al concentration gradient;

FIG. 4 is a process diagram showing a step of making a tunneling magnetic sensing element of an embodiment (a cross-sectional view of a tunneling magnetic sensing element during a production process taken in a direction parallel to a surface facing a recording medium);

FIG. 5 is a process diagram showing a step subsequent to the step shown in FIG. 4 (a cross-sectional view of a tunneling magnetic sensing element during a production process taken in a direction parallel to a surface facing a recording medium);

FIG. 6 is a process diagram showing a step subsequent to the step shown in FIG. 5 (a cross-sectional view of a tunneling magnetic sensing element during a production process taken in a direction parallel to a surface facing a recording medium);

FIG. 7 is a process diagram showing a step subsequent to the step shown in FIG. 6 (a cross-sectional view of a tunneling magnetic sensing element during a production process taken in a direction parallel to a surface facing a recording medium);

FIG. 8 is a graph showing the relationship between RA and the thickness of a CoFe layer (before oxidation) between a free magnetic layer and an Al—O layer of an insulating barrier layer of each of tunneling magnetic sensing elements of Samples 1 to 14 shown in Table 1;

FIG. 9 is a graph showing the relationship between the rate of change in resistance (ΔR/R) and the thickness of a CoFe layer (before oxidation) between a free magnetic layer and an Al—O layer of an insulating barrier layer of each of tunneling magnetic sensing elements of Samples 1 to 14 shown in Table 1; and

FIG. 10 is a graph showing the relationship between RA and the rate of change in resistance (ΔR/R) of each of tunneling magnetic sensing elements of Samples 1 to 14, the graph being prepared by combining the graphs in FIGS. 8 and 9.

### DESCRIPTION OF THE PREFERRED EMBODIMENTS

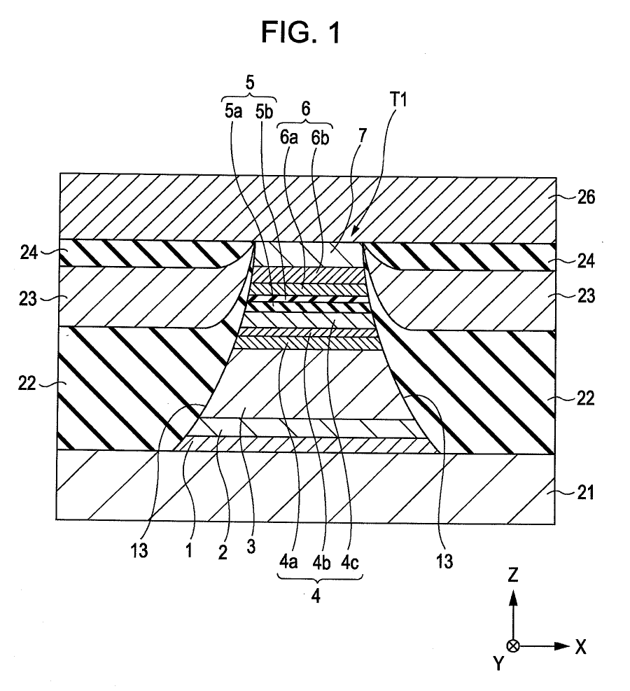

FIG. 1 is a cross-sectional view of a tunneling magnetic sensing element (tunneling magnetoresistive element) of an embodiment taken in a direction parallel to a surface facing a recording medium.

This tunneling magnetic sensing element is to be installed at a trailing side end of a floating slider of a hard disk device to detect a recording magnetic field of a hard disk or the like. The tunneling magnetic sensing element is also used as a MRAM (magnetoresistive memory).

In the drawing, the X direction is the track width direction, the Y direction is the direction of the leakage magnetic field from a magnetic recording medium (height direction), and the Z direction is the direction of movement of a magnetic recording medium such as a hard disk and the direction in which layers constituting the tunneling magnetic sensing element are stacked.

The bottom layer in FIG. 1 is a lower shield layer 21 composed of, for example, a NiFe alloy. A composite T1 is disposed on the lower shield layer 21. The tunneling magnetic sensing element includes the composite T1, and lower insulating layers 22, hard bias layers 23, and upper insulating layers 24 disposed at both sides of the composite T1 in the track width direction (X direction).

The bottom layer of the composite T1 is an underlayer 1 composed of a nonmagnetic material such as at least one element selected from Ta, Hf, Nb, Zr, Ti, Mo, and W. A seed layer 2 is disposed on the underlayer 1. The seed layer 2 is composed of, for example, NiFeCr. The seed layer 2 composed of NiFeCr has a face-centered cubic (fcc) structure in which equivalent crystal planes represented by {111} are preferentially aligned in a direction parallel to the surface. Alternatively, the underlayer 1 need not be provided.

An antiferromagnetic layer 3 disposed on the seed layer 2 is preferably composed of an antiferromagnetic material containing Mn and an element α (wherein α is at least one element selected from the group consisting of Pt, Pd, Ir, Rh, Ru, and Os).

An α-Mn alloy containing a platinum group element is an excellent antiferromagnetic material since it has high corrosion resistance and a high blocking temperature and can intensify the exchange coupling magnetic field (Hex).

Alternatively, the antiferromagnetic layer 3 may be composed of an antiferromagnetic material containing Mn, the element α, and an element α′ (wherein α′ is at least one element selected from the group consisting of Ne, Ar, Kr, Xe, Be, B, C, N, Mg, Al, Si, P, Ti, V, Cr, Fe, Co, Ni, Cu, Zn, Ga, Ge, Zr, Nb, Mo, Ag, Cd, Sn, Hf, Ta, W, Re, Au, Pb, and rare earth elements).

A pinned magnetic layer 4 is disposed on the antiferromagnetic layer 3. The pinned magnetic layer 4 has a layered ferrimagnetic structure in which a first pinned magnetic layer 4a, a nonmagnetic intermediate layer 4b, and a second pinned magnetic layer (insulating barrier layer-side magnetic layer) 4c are stacked in that order from the bottom. The magnetization direction of the first pinned magnetic layer 4a and the magnetization direction of the second pinned magnetic layer 4c are made antiparallel to each other by an antiferromagnetic exchange coupling magnetic field (Ruderman-Kittel-Kasuya-Yosida (RKKY) interaction) through the nonmagnetic intermediate layer 4b and the exchange coupling magnetic field at the interface between the pinned magnetic layer 4 and the antiferromagnetic layer 3. This is called a layered ferrimagnetic structure, which stabilizes the magnetization direction of the pinned magnetic layer 4 and can increase the apparent exchange coupling magnetic field generated at the interface between the pinned magnetic layer 4 and the antiferromagnetic layer 3. The first pinned magnetic layer 4a and the second pinned magnetic layer 4c each have a thickness of 12 to 24 Å, and the nonmagnetic intermediate layer 4b has a thickness of about 8 to 10 Å.

The first pinned magnetic layer 4a is composed of a ferromagnetic material such as CoFe, NiFe, or CoFeNi.

The nonmagnetic intermediate layer 4b is composed of a nonmagnetic conductive material such as Ru, Rh, Ir, Cr, Re, or Cu. The second pinned magnetic layer 4c may be composed of the same ferromagnetic material as the first pinned magnetic layer 4a but is preferably composed of CoFeB to improve the flatness of the surface and achieve a high rate of change in resistance (ΔR/R).

An insulating barrier layer 5 is disposed on the pinned magnetic layer 4. The insulating barrier layer 5 has a two-layer structure constituted by a lower insulating layer (pinned magnetic layer-side insulating layer) 5a and an upper insulating layer (free magnetic layer-side insulating layer) 5b.

The lower insulating layer 5a is composed of aluminum oxide (Al—O) and the upper insulating layer 5b is composed of cobalt iron oxide (CoFe—O).

As shown in FIG. 1, a free magnetic layer 6 is disposed on the insulating barrier layer 5. The free magnetic layer 6 is constituted by a soft magnetic layer 6b composed of a magnetic material such as a NiFe alloy or the like and an enhance layer 6a composed of a CoFe alloy and disposed between the soft magnetic layer 6b and the insulating barrier layer 5. The soft magnetic layer 6b is preferably composed of a magnetic material having excellent soft magnetic properties, and the enhance layer 6a is composed of a magnetic material having a spin polarization ratio higher than that of the soft magnetic layer 6b. The enhance layer 6a composed of a CoFe alloy having a high spin polarization ratio can improve the rate of change in resistance (ΔR/R). In this embodiment, the enhance layer 6a is preferably composed of CoFe having an Fe content of 5 at % or more and 95 at % or less. The soft magnetic layer 6b is preferably composed of a NiFe alloy having a Ni content of 80 at % to 95 at %.

The free magnetic layer 6 may have a layered ferrimagnetic structure in which a plurality of magnetic layers are stacked with nonmagnetic intermediate layers therebetween. The length of the free magnetic layer 6 in the track width direction (X direction) determines the track width TW.

A protective layer 7 composed of Ta or the like is disposed on the free magnetic layer 6.

Side faces 13 of the composite T1 in the track width direction (X direction) are formed as slopes so that the length in the track width direction gradually decreases from the bottom toward the top.

As shown in FIG. 1, the lower insulating layers 22 are formed over the lower shield layer 21 at the both sides of the composite Ti and the side faces 13 of the composite T1, and the hard bias layers 23 are disposed on the lower insulating layers 22. The upper insulating layers 24 are disposed on the hard bias layers 23.

A bias under layer (not shown) may be disposed between the lower insulating layer 22 and the hard bias layer 23. The bias under layer is, for example, composed of Cr, W, or Ti.

The insulating layers 22 and 24 are composed of an insulating material such as Al₂O₃ or SiO₂, and isolate the hard bias layers 23 from the layers above and below so as to suppress shunting of the current, which flows in a direction perpendicular to the interfaces of the layers of the composite T1, into both sides in the track width direction of the composite T1. The hard bias layers 23 are composed of a cobalt-platinum (Co—Pt) alloy or a cobalt-chromium-platinum (Co—Cr—Pt) alloy, for example.

An upper shield layer 26 composed of a NiFe alloy or the like is disposed on the composite T1 and the upper insulating layers 24.

In the embodiment shown in FIG. 1, the lower shield layer 21 and the upper shield layer 26 function as the electrode layers for the composite T1, and a current flows in a direction perpendicular to the interfaces of the layers of the composite T1, i.e., a direction parallel to the Z direction.

The free magnetic layer 6 is magnetized in a direction parallel to the track width direction (X direction) when a bias magnetic field is applied from the hard bias layers 23. On the other hand, the first pinned magnetic layer 4a and the second pinned magnetic layer 4c of the pinned magnetic layer 4 are magnetized in a direction parallel to the height direction (Y direction). Since the pinned magnetic layer 4 has a layered ferrimagnetic structure, the first pinned magnetic layer 4a and the second pinned magnetic layer 4c are magnetized in antiparallel to each other. While the magnetization direction of the pinned magnetic layer 4 is pinned, i.e., does not undergo changes by the external magnetic field, the magnetization direction of the free magnetic layer 6 changes with the external magnetic field.

As the magnetization direction of the free magnetic layer 6 changes with the external magnetic field, the flow of the tunneling current through the insulating barrier layer 5 between the second pinned magnetic layer 4c and the free magnetic layer 6 is obstructed due to antiparallel magnetization of the second pinned magnetic layer 4c and the free magnetic layer 6, thereby maximizing the resistance. In contrast, when the magnetization directions of the second pinned magnetic layer 4c and the free magnetic layer 6 are parallel to each other, the tunneling current smoothly flows, and the resistance is thereby minimized.

Due to this principle, changes in magnetization direction of the free magnetic layer 6 with the external magnetic field change the electrical resistance, and the changes in electrical resistance are detected as changes in voltage so that the leakage magnetic field from a recording medium can be detected.

Features of the embodiment shown in FIG. 1 will now be described.

In FIG. 1, the insulating barrier layer 5 has a layered structure including the lower insulating layer 5a composed of Al—O and the upper insulating layer 5b composed of CoFe—O. This structure can simultaneously achieve a low RA (element resistance R×element area A) and a high rate of change in resistance (ΔR/R).

As in this embodiment, interposition of the upper insulating layer 5b composed of CoFe—O between the lower insulating layer 5a composed of Al—O and the free magnetic layer 6 improves the spin polarization ratio near the interface between the insulating barrier layer 5 and the free magnetic layer 6. Thus, the rate of change in resistance (ΔR/R) is improved.

The average thickness of the upper insulating layer 5b is preferably smaller than that of the lower insulating layer 5a. In this manner, the decrease in rate of change in resistance (ΔR/R) can be suppressed. In particular, in order to achieve the rate of change in resistance (ΔR/R) comparable or superior to that of a related structure (structure in which the insulating barrier layer is an Al—O single layer), the average thickness of the upper insulating layer 5b is preferably in the range of 0 to 4 Å. The average thickness of the upper insulating layer 5b is more preferably in the range of 0 to 3 Å, yet more preferably in the range of 0 to 2 Å, and most preferably in the range of 0.5 to 1.5 Å.

The lower insulating layer 5a is preferably composed of an oxide of Co_{100-X}Feₓ, which has an Fe content X in the range of 10 to 90 at %. When the lower insulating layer 5a is composed of an oxide of CoFe having the above-described composition, the rate of change in resistance (ΔR/R) can be effectively improved and RA can be effectively decreased.

The average thickness of the lower insulating layer 5a is preferably in the range of 5 to 15 Å.

As described above, in this embodiment, RA lower than that of the related structure can be achieved. RA is an important parameter for optimizing the high-speed data transfer and achieving high density recording and needs to be set to a low value. In this embodiment, RA can be set to a value smaller than 5 Ωμm², preferably 4.5 Ωμm² or less. It should be noted that the element area A (the average area of the composite T1 in the X-Y plane in the drawing) is in the range of 0.02 to 0.25 μm². For example, RA generally increases by narrowing the track or reducing the length of the composite T1 in the Y direction; however, in this embodiment, RA can be kept to a level lower than that of the related structure even when the track is narrowed or the length of the composite T1 in the Y direction is reduced.

The track width Tw is 0.2 μm or less and preferably 0.1 μm or less. The length of the composite T1 in the Y direction is preferably 0.2 μm or less.

The tunneling magnetic sensing element is annealed (heat-treated) in the course of production, as described below. The annealing temperature is, for example, about 240° C. to 310° C. For example, the annealing is performed in a magnetic field so as to generate an exchange coupling magnetic field (Hex) between the first pinned magnetic layer 4a of the pinned magnetic layer 4 and the antiferromagnetic layer 3.

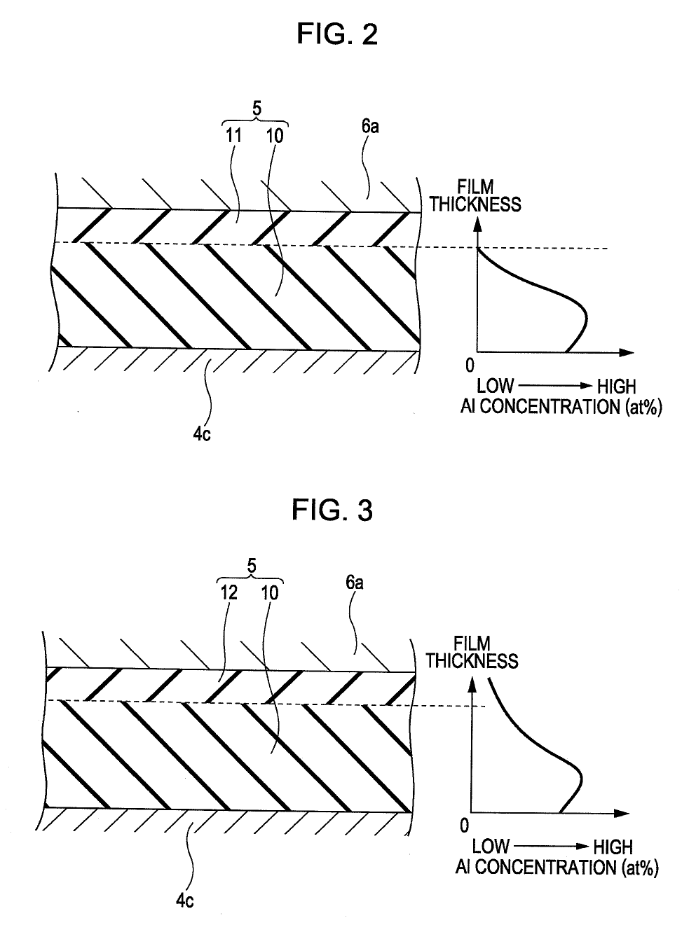

It is believed that as a result of the annealing, interdiffusion of the elements constituting the lower insulating layer 5a and the upper insulating layer 5b occurs at the interface as shown in FIGS. 2 and 3, so that the interface no longer exists.

The embodiments shown in FIGS. 2 and 3 schematically show the diffusion of elements at the interface between the lower insulating layer 5a and the upper insulating layer 5b. In the embodiment shown in FIG. 2, no aluminum is contained in an upper insulating region 11. The upper insulating region 11 is composed of CoFe—O. In contrast, a lower insulating region 10 under the upper insulating region 11 is mainly composed of Al—O.

In the embodiment shown in FIG. 3, aluminum is diffused in the entire insulating barrier layer 5. The Al concentration is lower at the upper surface side near the enhance layer 6a than at the lower surface side near the second pinned magnetic layer 4c. As shown in FIG. 3, the lower insulating region 10 includes a composition gradient region where the Al concentration gradually decreases from the lower surface side near the second pinned magnetic layer 4c toward an upper insulating region 12. In this embodiment, the upper insulating region 12 is composed of CoFeAl—O.

Presumably, the element diffusion described above affects the crystal structure of the insulating barrier layer 5 interior and the like and contributes to improving the rate of change in resistance (ΔR/R).

It should be noted here that if annealing is not conducted or if annealing is conducted at a temperature lower than 240° C., the above-described element diffusion does not occur or only occurs in a small scale (e.g., diffusion does not occur over the entire interface but only intermittently). Under such a circumstance, the interface presumably keeps existing substantially as it is.

In the embodiment shown in FIG. 1, the antiferromagnetic layer 3, the pinned magnetic layer 4, the insulating barrier layer 5, and the free magnetic layer 6 are stacked in that order from the bottom. Alternatively, the order of stacking may be reversed so that the free magnetic layer 6, the insulating barrier layer 5, the pinned magnetic layer 4, and the antiferromagnetic layer 3 are stacked in that order from the bottom. However, in the structure shown in FIG. 1 in which the pinned magnetic layer 4 is disposed under the insulating barrier layer 5, the flatness of the second pinned magnetic layer 4c can be enhanced by forming the second pinned magnetic layer 4c with CoFeB and the rate of change in resistance (ΔR/R) can be further improved as a result.

The second pinned magnetic layer 4c is composed of (Co_{1-Y}Fe_{Y})_{z}B_{100-Z}. The atomic ratio Y is preferably in the range of 0.05 to 0.95 at % and the atomic ratio Z is preferably in the range of 50 to 90 at % in order to achieve a high rate of change in resistance (ΔR/R). The second pinned magnetic layer 4c may have a layered structure constituted by CoFeB and CoFe layers (the CoFeB layer being in contact with the insulating barrier layer 5).

This embodiment may be applied to a dual-type tunneling magnetic sensing element in which a lower antiferromagnetic layer, a lower pinned magnetic layer, a lower insulating barrier layer, a free magnetic layer, an upper insulating barrier layer, an upper pinned magnetic layer, and an upper antiferromagnetic layer are stacked in that order from the bottom. In such a case, insulating layers composed of CoFe—O are respectively provided between the lower insulating barrier layer and the free magnetic layer and between the upper insulating barrier layer and the free magnetic layer, and insulating layers composed of Al—O are respectively provided between the lower insulating barrier layer and the lower pinned magnetic layer and between the upper insulating barrier layer and the upper pinned magnetic layer.

In the embodiment shown in FIG. 1, the pinned magnetic layer 4 has a layered ferrimagnetic structure including the first pinned magnetic layer 4a, the nonmagnetic intermediate layer 4b, and the second pinned magnetic layer 4c. Alternatively, for example, the pinned magnetic layer 4 may be a single layer or have a multilayer structure including a plurality of magnetic layers. If the pinned magnetic layer 4 is designed as a single layer, CoFeB is preferably used and if the pinned magnetic layer 4 is designed as a multilayer structure including a plurality of magnetic layers, at least the magnetic layer in contact with the insulating barrier layer is preferably composed of CoFeB to achieve a high rate of change in resistance (ΔR/R).

Note that in the embodiments described above, the lower insulating layer 5a is composed of Al—O. Alternatively, Mg—O may be used instead of Al—O and the same advantages can be achieved.

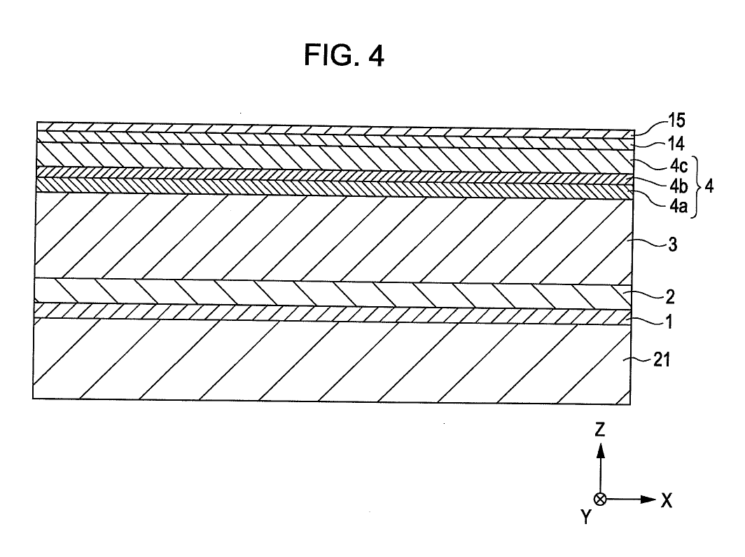

A method for making the tunneling magnetic sensing element of an embodiment will now be described. FIGS. 4 to 7 are partial cross-sectional views of a tunneling magnetic sensing element during a production process taken in the same direction as FIG. 1.

In the step shown in FIG. 4, the underlayer 1, the seed layer 2, the antiferromagnetic layer 3, the first pinned magnetic layer 4a, the nonmagnetic intermediate layer 4b, and the second pinned magnetic layer 4c are continuously sputter-deposited on the lower shield layer 21.

In this step, the second pinned magnetic layer 4c is preferably made of (CO_{1-Y}Fe_{Y})_{Z}B_{100-Z}, the atomic ratio Y is preferably in the range of 0.05 to 0.95 at %, and the atomic ratio Z is preferably 50 to 90 at % in order to achieve a high rate of change in resistance (ΔR/R).

The surface of the second pinned magnetic layer 4c is then plasma-treated to further enhance flatness.

Next, an aluminum layer 14 is formed on the second pinned magnetic layer 4c by sputtering or the like. In this embodiment, the aluminum layer 14 is preferably formed to have an average thickness of 2 to 10 Å.

Next, the a CoFe layer 15 is formed on the aluminum layer 14 by sputtering or the like. In this embodiment, a CoFe layer 15 composed of CO_{100-X}Fe_{X} in which the Fe content X is in the range of 10 to 90 at % is preferably formed. The average thickness of the CoFe layer 15 is preferably more than 0 Å but not more than 1.6 Å, more preferably more than 0 Å but not more than 1.2 Å, yet more preferably more than 0 Å but not more than 0.8 Å, and most preferably 0.2 Å or more but not more than 0.6 Å. In this manner, a rate of change in resistance (ΔR/R) comparable or superior to that of a related structure (structure in which the insulating barrier layer is an Al—O single layer) can be achieved, and a tunneling magnetic sensing element that can achieve RA (element resistance R×element area A) lower than that of the related structure can be adequately and easily produced.

The aluminum layer 14 and the CoFe layer 15 are then oxidized. As a result, an insulating barrier layer 5 that has a layered structure constituted by a lower insulating layer (pinned magnetic layer-side insulating layer) 5a formed by oxidation of the aluminum layer 14 and composed of Al—O and a upper insulating layer (free magnetic layer-side insulating layer) 5b formed by oxidation of the CoFe layer 15 and composed of CoFe—O is made. Examples of the methods for oxidation include radical oxidation, ion oxidation, plasma oxidation, and natural oxidation.

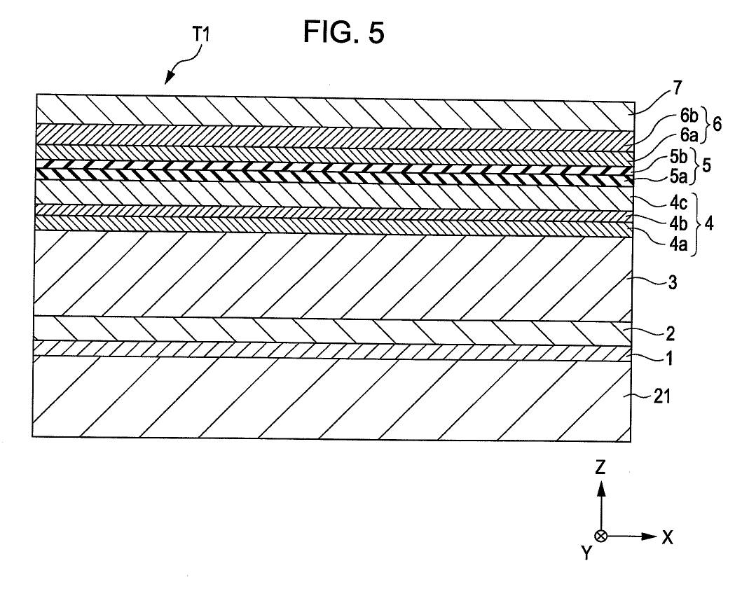

Next, in the step shown in FIG. 5, the free magnetic layer 6 constituted by the enhance layer 6a and the soft magnetic layer 6b is formed on the insulating barrier layer 5, and the protective layer 7 is formed on the free magnetic layer 6.

In this embodiment, the enhance layer 6a is preferably composed of CoFe having an Fe content of 5 at % or more and 95 at % or less. The soft magnetic layer 6b is preferably composed of a NiFe alloy having a Ni content of 80 at % to 95 at %.

A composite T1 having the layers from the underlayer 1 to the protective layer 7 is formed as above.

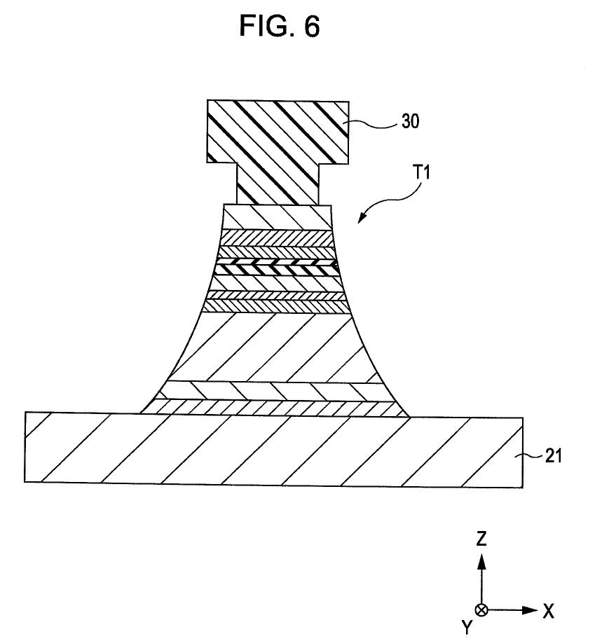

Next, a lift-off resist layer 30 is formed on the composite T1, and two side end portions of the composite T1 in the track width direction (X direction) uncovered by the lift-off resist layer 30 are removed by etching or the like (see FIG. 6).

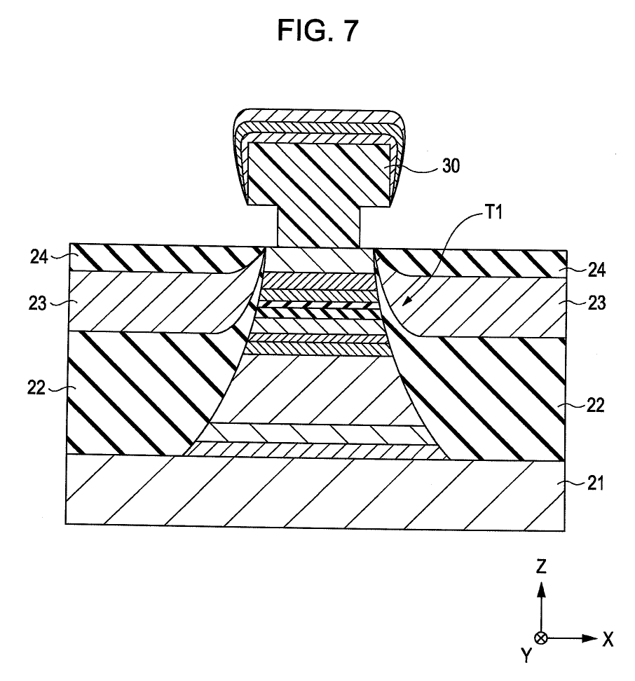

Next, as shown in FIG. 7, the lower insulating layers 22, the hard bias layers 23, and the upper insulating layers 24 are sequentially formed on the lower shield layer 21 in that order at the two sides of the composite T1 in the track width direction (X direction).

The lift-off resist layer 30 is then removed, and the upper shield layer 26 is formed on the composite T1 and the upper insulating layers 24.

In the method for making the tunneling magnetic sensing element described above, annealing is performed in the course of manufacture. A representative example of the annealing is magnetic field annealing for generating an exchange coupling magnetic field (Hex) between the antiferromagnetic layer 3 and the pinned magnetic layer 4.

The annealing temperature is, for example, in the range of 240° C. to 310° C. and it is believed that interdiffusion of constituent elements occurs at the interfaces of the layers by the annealing. As a result of the annealing, it is believed that interdiffusion between the lower insulating layer 5a composed of Al—O and the upper insulating layer 5b composed of CoFe—O occurs inside the insulating barrier layer 5.

In the cases where no annealing is performed or annealing is performed at a temperature lower than 240° C., interdiffusion of the constituent elements at the interface of the layers does not occur or only occurs in a small scale (e.g., diffusion does not occur over the entire interface but only intermittently). Under such a circumstance, the interface presumably keeps existing substantially as it is.

In this embodiment, a tunneling magnetic sensing element that can achieve a high rate of change in resistance (ΔR/R) and a low RA (element resistance R×element area A) can be easily and adequately produced by the above-described method.

In particular, by adjusting the thickness of the CoFe layer 15 as described above, an RA lower than that of the related structure and a high rate of change in resistance (ΔR/R) can be reliably achieved.

In the case where the free magnetic layer 6, the insulating barrier layer 5, the pinned magnetic layer 4, and the antiferromagnetic layer 3 are stacked in that order from the bottom, the CoFe layer 15 may be formed on the free magnetic layer 6, the aluminum layer 14 may be formed on the CoFe layer 15, and then the CoFe layer 15 and the aluminum layer 14 may be oxidized to form the insulating barrier layer 5 constituted by an insulating layer composed of CoFe—O and an insulating layer composed of Al—O. In such a case, the average thickness of the CoFe layer 15 and the like are the same as those described with reference to FIG. 4.

In the case where the lower insulating layer 5a of the insulating barrier layer 5 is formed with Mg—O, an Mg layer is formed instead of the Al layer and the Mg layer is oxidized to form the Mg—O layer.

### EXAMPLES

A tunneling magnetic sensing element illustrated in FIG. 1 was formed.

A composite T1 was formed by stacking the following layers in that order: underlayer 1, Ta (30)/seed layer 2, (Ni_{0.8}Fe_{0.2})_{60at%}Cr_{40at%} (50)/antiferromagnetic layer 3, IrMn (70)/pinned magnetic layer 4 [first pinned magnetic layer 4a, Co_{70at%}Fe_{30at%} (14)/nonmagnetic intermediate layer 4b, Ru (8.5)/second pinned magnetic layer 4c, (CO_{0.75}Fe_{0.25})_{80at%}B_{20at%} (18)]/insulating barrier layer 5/free magnetic layer 6 [enhance layer 6a, Co_{70at% Fe}_{30at%} (10)/soft magnetic layer 6b, Ni_{83.5at%}Fe_{16.5at%} (40)]/protective layer 7, [Ru (20)/Ta (175)]. The figures in the parentheses indicate average thicknesses in angstrom.

As shown in Table 1 below, the insulating barrier layers of Samples 1 and 8 were each formed by oxidizing an Al single layer. In Samples 2 to 7 and 9 to 14, the insulating barrier layers were each formed by oxidizing an Al (lower)/Co_{70at%}Fe_{30at%} (upper) layered structure. As shown in Table 1, in Samples 1 to 7, the average thickness of the Al layer was 4.3 Å; in samples 8 to 14, the average thickness of the Al layer was 4.6 Å; and in Samples 2 to 7 and 9 to 14, the average thickness of the CoFe layer was varied.

The surface of the second pinned magnetic layer 4c was treated with plasma before formation of the insulating barrier layer 5.

In each Sample, the element area (average area of the X-Y plane of the composite T1) was made the same.

The experiment was conducted to determine the relationships with RA (element resistance R×element area A) and the rate of change in resistance (ΔR/R) for each of the tunneling magnetic sensing elements of Samples 1 to 14.

TABLE 1

Barrier

| | Al thickness | CoFe thickness | RA | ΔR/R |
|---|---|---|---|---|
| No. | (Å) | (Å) | (Ω um²) | (%) |
| 1 | 4.30 | 0.0 | 4.72 | 23.6 |
| 2 | 4.30 | 0.4 | 3.77 | 26.2 |
| 3 | 4.30 | 0.8 | 3.48 | 24.7 |
| 4 | 4.30 | 1.2 | 3.13 | 23.9 |
| 5 | 4.30 | 1.6 | 2.92 | 22.9 |
| 6 | 4.30 | 2.0 | 2.81 | 21.5 |
| 7 | 4.30 | 2.4 | 2.74 | 19.8 |
| 8 | 4.60 | 0.0 | 5.08 | 24.7 |
| 9 | 4.60 | 0.4 | 4.72 | 27.4 |
| 10 | 4.60 | 0.8 | 4.23 | 24.7 |
| 11 | 4.60 | 1.2 | 4.05 | 24.6 |
| 12 | 4.60 | 1.6 | 3.54 | 24.0 |
| 13 | 4.60 | 2.0 | 3.24 | 22.0 |
| 14 | 4.60 | 2.4 | 3.18 | 20.5 |

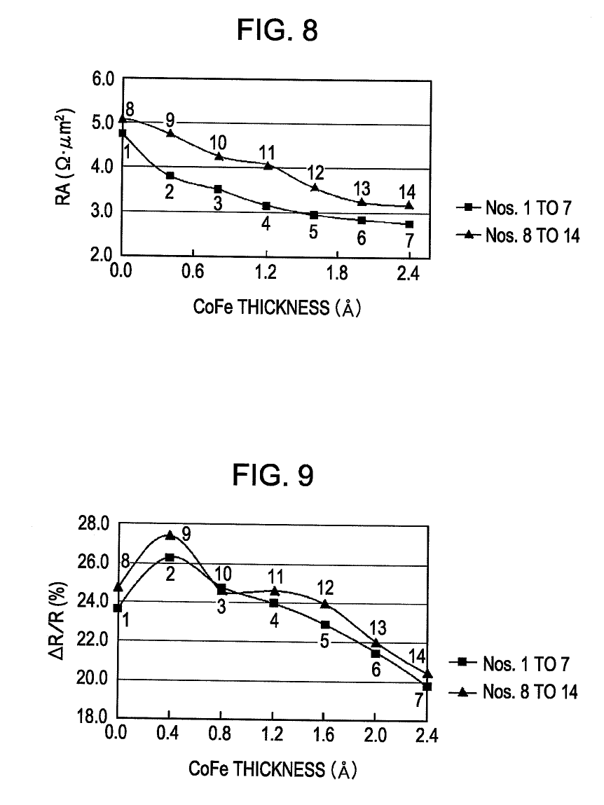

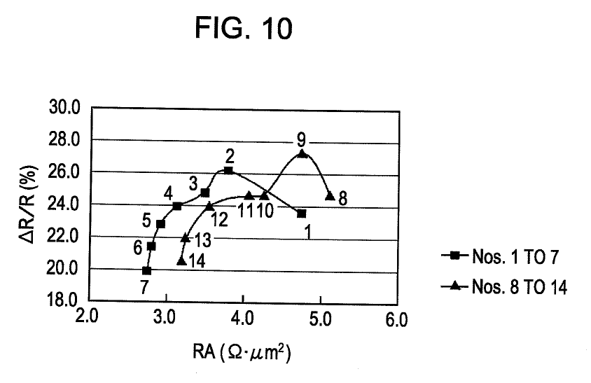

On the basis of the experimental results shown in Table 1, the relationship between RA and the average thickness of the CoFe layer (before oxidation) constituting the insulating barrier layer of each sample was plotted as shown in the graph of FIG. 8; the relationship between the rate of change in resistance (ΔR/R) and the average thickness of the CoFe layer (before oxidation) constituting the insulating barrier layer of each sample was plotted as shown in the graph of FIG. 9; and the relationship between RA and the rate of change in resistance (ΔR/R) of each sample was plotted as shown in the graph of FIG. 10. The numbers indicated in the graph correspond to the sample numbers.

As shown in FIG. 8, the RA gradually decreased with the increase in average thickness of the CoFe layer.

As shown in FIG. 9, the rate of change in resistance (ΔR/R) increased with the average thickness of the CoFe layer up to a certain point and then gradually decreased with the further increase in average thickness of the CoFe layer.

As shown in FIGS. 8 to 10, in order to achieve a rate of change in resistance (ΔR/R) higher than or equal to that of the related structure (Al—O single layer structure) indicated by Samples 1 and 8 and an RA lower than that of the related structure, the average thickness of the CoFe layer should be adjusted to more than 0 Å but not more than 1.6 Å, preferably more than 0 Å but not more than 1.2 Å, more preferably more than 0 Å but not more than 0.8 Å, and most preferably 0.2 Å or more and 0.6 Å or less.

What is claimed is:

1. A tunneling magnetic sensing element comprising:
a pinned magnetic layer having a magnetization direction pinned;
an insulating barrier layer; and
a free magnetic layer having a magnetization direction variable with an external magnetic field,
wherein the pinned magnetic layer, the insulating barrier layer, and the free magnetic layer are stacked in that order or a reversed order from the bottom, and
the insulating barrier layer has a layered structure that includes a pinned magnetic layer-side insulating layer composed of Al—O or Mg—O disposed at the interface between the pinned magnetic layer and the insulating barrier layer and a free magnetic layer-side insulating layer composed of CoFe—O disposed at the interface between the free magnetic layer and the insulating barrier layer.

2. The tunneling magnetic sensing element according to claim 1, wherein the average thickness of the free magnetic layer-side insulating layer is smaller than the average thickness of the pinned magnetic layer-side insulating layer.

3. The tunneling magnetic sensing element according to claim 1, wherein interdiffusion of constituent elements occurs at the interface between the free magnetic layer-side insulating layer and the pinned magnetic layer-side insulating layer.

4. The tunneling magnetic sensing element according to claim 1, wherein the pinned magnetic layer, the insulating barrier layer, and the free magnetic layer are stacked in that order from the bottom.

5. The tunneling magnetic sensing element according to claim 4, wherein the pinned magnetic layer has a layered structure at least including an insulating barrier layer-side magnetic layer in contact with the insulating barrier layer, and the insulating barrier layer-side magnetic layer is composed of CoFeB or has a layered structure including a CoFeB layer in contact with the insulating barrier layer and a CoFe layer.

6. A method for making a tunneling magnetic sensing element, comprising:
stacking a pinned magnetic layer having a magnetization direction pinned, an insulating barrier layer, and a free magnetic layer having a magnetization direction variable with an external magnetic field, either in that order or a reversed order from the bottom,
wherein, in forming the insulating barrier layer, an Al layer or a Mg layer is formed at the side in contact with the pinned magnetic layer, a CoFe layer is formed at the side in contact with the free magnetic layer, and then the Al or Mg layer and the CoFe layer are oxidized.

7. The method according to claim 6, wherein the average thickness of the CoFe layer is more than 0 Å but not more than 1.6 Å.

8. The method according to claim 7, wherein the average thickness of the CoFe layer is more than 0 Å but not more than 1.2 Å.

9. The method according to claim 6, wherein the pinned magnetic layer, the insulating barrier layer, and the free magnetic layer are stacked in that order from the bottom, and in forming the insulating barrier layer, the Al or Mg layer and the CoFe layer are stacked in that order from the bottom and then oxidized.
